(19) United States
(12) Patent Application Publication
(10) Pub. No.: US 2024/0025283 A1
(43) Pub. Date: Jan. 25, 2024

(54) SYSTEM AND PROCESS OF RECHARGING ELECTRIC OR HYBRID VEHICLES IN AN AUTOMATED PARKING AREA

(71) Applicant: SOTEFIN PATENTS SA, (US)

(72) Inventor: Giovanni VALLI, Cantello (VA) (IT)

(21) Appl. No.: 18/222,119

(22) Filed: Jul. 14, 2023

(30) Foreign Application Priority Data
Jul. 20, 2022 (IT) 102022000015213

(51) Int. Cl. B60L 53/31; B60L 53/16; B60L 53/18; B60L 53/36

(52) U.S. Cl. CPC B60L 53/31; B60L 53/16; B60L 53/18; B60L 53/36

(57) ABSTRACT

A system and a process of recharging electric or hybrid vehicles in an automated parking area is described, said recharging process comprising the steps of:
providing a vehicle (300) to be recharged to an interface platform (200) between the vehicle and a carriage for moving vehicles; said interface platform (200) being combined with a first horizontal conveyor device (20); said first horizontal conveyor device (20) being in turn coupled to a recharging column (10), the drag plate (22) and said recharging column (10) being in their at rest/recharging position;
bringing said drag plate (22) and said recharging column (10) to a conveying/forward position;
bringing a carriage for moving vehicles below said vehicle (300);
coupling at least one portion of said carriage for moving vehicles to at least one wheel of said vehicle (300) and to said recharging column (10); such as to decouple said recharging column (10) from said first horizontal conveyor device (20);
conveying said vehicle (300) together with said recharging column (10) on a parking spot (400) provided with a second horizontal conveyor device (20);
coupling said recharging column (10) to the drag plate (22) of said second horizontal conveyor device (20);
translating said drag plate (22) of said second conveyor device (20) together with said recharging column (10) in its at rest/recharging position such as the power socket (6) of said column (10) is engaged with and is electrically supplied by a corresponding power socket (18).

### FIELD OF THE INVENTION

The present invention concerns a recharging system for recharging electric or hybrid vehicles in an automated parking area.

### KNOWN ART

As is known, automated parking areas or multistorey car park are structures adapted to accommodate vehicles, such as cars and trucks.

In multistorey car park, the vehicle is typically left by its driver at an access area where an automatic parking procedure is thus actuated and through which parking procedure the vehicle is collected by electromechanical devices from the access area for being deposited in an appropriate parking spot. Similarly, the vehicle is pulled out of the automatic parking area by means of a reverse procedure which provides to collect the vehicle, by means of electromechanical devices, from the parking spot and to reposition it in the access area, ready to be collected by the driver. In automated parking area or multistorey car parks such operations occur automatically, for example as a result of the user pressing a button or other known activation means.

In recent years, the proliferation of cars of the hybrid or electric type, in which the drive is no longer given by an engine of the endothermic type but rather supplied by an electric battery, has been noted. In order to be used, such cars require to be recharged by means of electric current at the end of charge period of their batteries. Typically, the recharging of an electric or hybrid car occurs through a power socket into which a plug connected with the car itself is inserted.

The Applicant has noted that the vehicle recharging operation is not always easy in automated parking areas, since the user cannot access the parking spots but only the access area. In spaces in which there are parking spots, movement carriages and movement guides for moving the carriages and other metal structures, which could be dangerous for users, are in fact present. In fact, it is sufficient to think that in such spaces, the carriages for moving cars move automatically whenever vehicles are being displaced or pull out of the parking area.

The Applicant has thus addressed the problem of implementing a simple and simultaneously reliable recharging system which can be used inside automated multistorey car parks or parking areas, such as to prevent the user from being exposed to risks in unsafe environments or while moving vehicles in the spaces in which the parking spots are located.

The Applicant has thus further addressed the problem of implementing a process which uses the new recharging system, which allows to prevent the user from being exposed to risks in unsafe environments or while moving vehicles in the spaces in which the parking spots are located.

Finally, the Applicant has further addressed the problem of implementing a system and a process for recharging electric and/or hybrid vehicles inside automated multistorey car parks or parking areas, which minimizes human intervention.

### SUMMARY OF THE INVENTION

Therefore, in its first aspect, the invention concerns a recharging column for recharging electric or hybrid vehicles in an automated parking area, said column extending substantially vertically and comprising:
a supporting upright extending substantially vertically;
a power socket positioned in said column, and
a first connector configured to be coupled to a corresponding connector of the vehicle to be recharged;
a current cable provided with said first connector at one end,
a power socket configured for being coupled to a corresponding power socket outside of the column from which to receive the electric power supply; said power socket of the recharging column being electrically connected to said electric cable;
a base configured to support said column and to move on a drag base of a horizontal conveyor device to translate said column between an at rest/recharging position and a conveying/forward position;
a hooking element integral with the base and comprising reversible coupling means for coupling to a carriage for moving the vehicle;
said hooking element comprising reversible coupling means for coupling to a drag base of a horizontal conveyor device.

In the context of the present invention, “automated parking area” means a parking area in which it is possible to position a vehicle in a first station and to subsequently, by means of user interface means, cause the activation of an automatic system for moving the vehicle which uses a movement carriage performing the translation, raising and/or lowering and/or rotation of said vehicle up to a parking area or parking station with a predetermined stall inside which the vehicle is specifically arranged in a predefined parking stall, by means of an automatic movement procedure assisted by the control of an electronic processor and by electric motorized means for controlling said movement carriage.

“Reversible coupling means” are coupling means configured to allow the coupling or decoupling freely of two or more parts upon request of the user.

In the aforesaid aspect, the present invention can have at least one of the preferred characteristics described hereunder.

Preferably, the power socket is integral with the base such as to translate together with the latter.

Conveniently, the hooking element comprises two recesses configured to allow the insertion of a grip portion of a carriage for moving vehicles.

Preferably, the coupling means are configured to interact magnetically with corresponding reversible coupling means of a drag base of a horizontal conveyor device.

According to a further aspect, the present invention concerns a horizontal conveyor device for a recharging column of electric or hybrid vehicles in an automated parking area; the conveyor device comprising:
a horizontal guide;
a drag base configured to be reversibly coupled to a hooking element of a recharging column of electric or hybrid vehicles in an automated parking area; said drag base being configured to translate along the horizontal guide between an at rest/recharging position and a conveying/forward position;
a motor configured to transmit the translation movement to said drag base;
a supporting frame configured to at least partially contain said horizontal guide.

Preferably, the conveyor device comprises reversible coupling means of the magnetic type for coupling to a hooking element of a recharging column for recharging electric or hybrid vehicles.

Still according to a further aspect, the present invention concerns a recharging system for recharging electric or hybrid vehicles in an automated parking area, comprising:
at least one recharging column as previously described;
at least one first conveyor device as previously described and arranged at an interface platform between the vehicle to be parked and a carriage for moving vehicles in an automated parking area;
at least one second conveyor device as previously described and arranged at a parking spot of a vehicle in an automated parking area.

Preferably, the recharging system for recharging electric or hybrid vehicles in an automated parking area comprises a plurality of recharging columns for recharging electric or hybrid vehicles in an automated parking area.

Advantageously, the recharging system for recharging electric or hybrid vehicles in an automated parking area comprises a robotic arm configured to move the recharging columns from a storage position to a coupled position with the first conveyor device and vice-versa.

Preferably, the recharging system for recharging electric or hybrid vehicles in an automated parking area comprises a storage warehouse for storing the plurality of recharging columns, the storage warehouse being positioned at an interface platform between the vehicle to be parked and a carriage for moving vehicles in an automated parking area.

Finally, according to a further aspect, the present invention concerns a process of recharging electric or hybrid vehicles in an automated parking area with a recharging system for recharging electric or hybrid vehicles as previously described.

The recharging process comprising the steps of:
providing a vehicle to be recharged to an interface platform between the vehicle and a carriage for moving vehicles; said interface platform being combined with a first horizontal conveyor device as previously described; said first horizontal conveyor device being in turn coupled to a recharging column as previously described, the drag plate and said recharging column being in their at rest/recharging position;
bringing the drag plate and the recharging column to a conveying/forward position;
bringing a carriage for moving vehicles below said vehicle;
coupling at least one portion of said carriage for moving vehicles to at least one wheel of said vehicle and to the recharging column; such as to decouple said recharging column from said first horizontal conveyor device;
conveying said vehicle together with said recharging column on a parking spot provided with a second horizontal conveyor device;
coupling the recharging column to the drag plate of the second horizontal convey or device;
translating the drag plate of the second conveyor device together with the recharging column in its at rest/recharging position such as the power socket of the column is engaged with and is electrically supplied by a corresponding power socket.

Advantageously, the step of coupling at least one portion of said carriage for moving vehicles to at least one wheel of the vehicle and to said recharging column provides for the engagement of a gripping member of the carriage for moving vehicles with the hooking element and the raising of the hooking element to decouple the reversible coupling means of the recharging column from the corresponding reversible coupling means of the drag base of a horizontal conveyor device.

Preferably, the step of coupling the recharging column to the drag plate of said second horizontal conveyor device occurs by coupling the hooking element to the drag base such as to couple the reversible coupling means of the recharging column to the corresponding reversible coupling means of the second conveyor device.

Further characteristics and advantages of the invention will become clearer in the detailed description of some preferred, but not exclusive, embodiments of a recharging system for recharging electric or hybrid vehicles in an automated parking area according to the present invention.

### BRIEF DESCRIPTION OF THE DRAWINGS

Such description will be set forth hereunder with reference to the accompanying drawings provided by way of example only and thus not limiting, in which:

FIG. 1 shows a schematic perspective view of a recharging column for recharging electric or hybrid vehicles in an automated parking area according to the present invention;

FIG. 2 is a schematic perspective view of the recharging column of FIG. 1 applied to a horizontal conveyor device for a recharging column according to the present invention;

FIG. 3 is a schematic perspective view of the horizontal conveyor device for a recharging column of FIG. 2;

FIG. 4 is a schematic view of the access space for accessing an automated parking area comprising a recharging system according to the present invention;

FIG. 5 is a schematic view of the access space for accessing an automated parking area of FIG. 4 with a vehicle positioned on the interface platform between the vehicle to be parked and a carriage for moving vehicles;

FIG. 6 is a schematic front view of the vehicle of FIG. 5 positioned on the interface platform between the vehicle to be parked and a carriage for moving vehicles, with the recharging column translated towards the wheel of the vehicle;

FIG. 7 is a schematic front view of the vehicle of FIG. 5 positioned on the parking spot, with the recharging column in the conveying/forward position; and

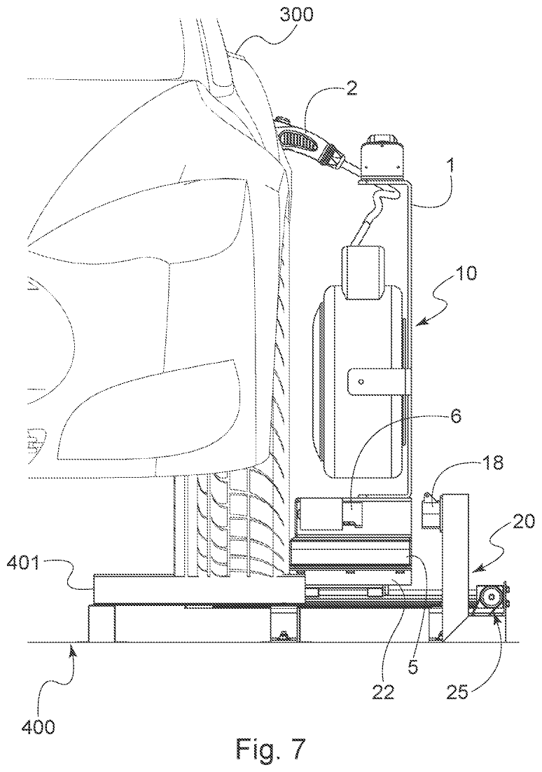

FIG. 8 is a schematic front view of the vehicle of FIG. 5 positioned on the parking spot, with the recharging column in the at rest/recharging position.

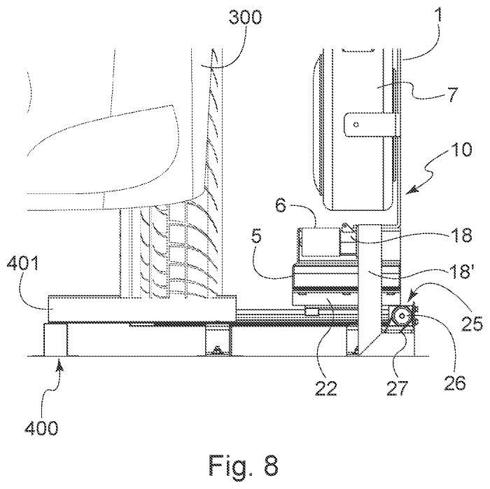

### DETAILED DESCRIPTION OF EMBODIMENTS OF THE INVENTION

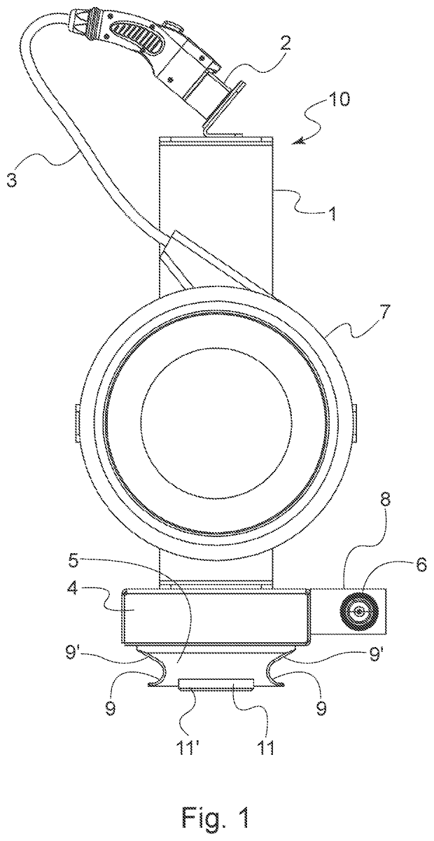

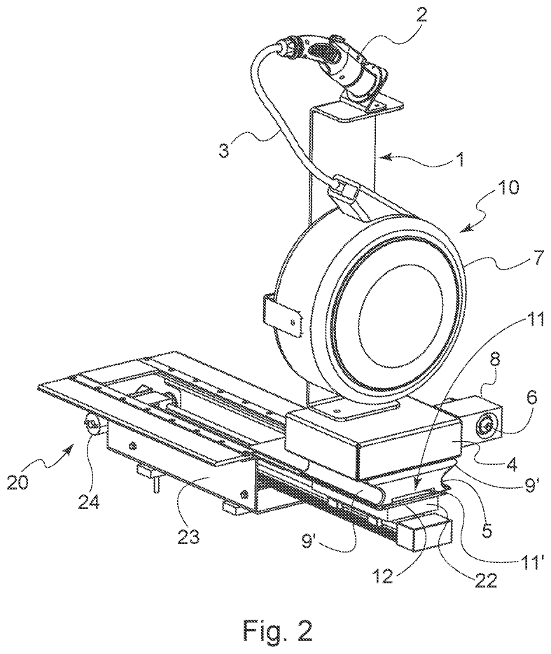

With reference to the figures and in particular to FIGS. 1 and 2, a recharging column for recharging electric or hybrid vehicles in an automated parking area, according to the present invention, is denoted by the numerical reference 10.

The recharging column 10 has a supporting upright 1 extending substantially vertically from a supporting base 4. The recharging column 10 is further provided with an electric cable 3 provided at one end with a first connector 2 configured to be coupled to the connector corresponding to the vehicle to be recharged.

The electric cable 3 is further functionally combined with a power socket 6.

Advantageously, the recharging column 10 has a cable winder 7 onto which the electric cable 3 is automatically wound by means of elastic means not shown in the figures.

Preferably, the power socket 6 is a power socket of female type, i.e. adapted for being coupled to a corresponding socket 18 of male type outside the recharging column 10 and configured for electrically supplying the power socket 6.

Preferably, the power socket 6 has electric contacts adapted for being able to transfer electric power with a voltage approximately ranging between 200V and 500V and with currents above 10 A. The current IEC 62-196 standard in fact provides for recharging currents between 16 A and 32 A with single-phase recharging systems at 250V or up to 63 A on 480V voltages.

Moreover, the power socket 6 preferably has an IPXXB or IPXXD standard. Thus, even if it were powered, the finger of the user would not reach the active parts, namely the contacts, thus preventing the risk of electrocution.

In the embodiment shown in the figures, the power socket 6 is supported by a box-shaped arm 8 extending sideways from the supporting base 4.

The box-shaped arm 8, and consequently the power socket 6, moves integrally with the supporting base 4 for being coupled to a male power socket 18, such as to power the column 1 and consequently the connector 2, or decoupled from the corresponding power socket 18.

The supporting base 4 is constrained at the bottom and integral with a hooking element 5 configured for being coupled to a carriage for moving vehicles.

In particular, in the embodiment shown in FIGS. 1 and 2, the hooking element 5 has two recesses 9 configured to allow the insertion of a portion of a carriage for moving vehicles.

In particular, the two recesses 9 are spaced from one another and configured for being coupled to a tooth or a clamping device of a carriage for conveying vehicles.

Preferably, the two recesses 9 have the same shape and size and can have an inclined surface 9′ configured for being coupled to a corresponding surface of a clamping device of a carriage for conveying vehicles, such as those described in the patent application WO2015177718 in the name of the same Applicant.

Alternatively, the two recesses 9 are configured for being coupled to two teeth of a carriage for moving vehicles, such as those described in the patent application WO02075084 always in the name of the Applicant.

Advantageously, the hooking element 5 comprises reversible coupling means 11 for coupling to a drag base 22 of a horizontal conveyor device 20, as better described hereunder.

The reversible coupling means 11 are configured to interact magnetically with corresponding reversible coupling means of a drag base 22 of a horizontal conveyor device 20. The reversible coupling means 11 can be represented by a magnet 11′ of appropriate size and capacity and positioned on the surface facing the bottom of the hooking element 5.

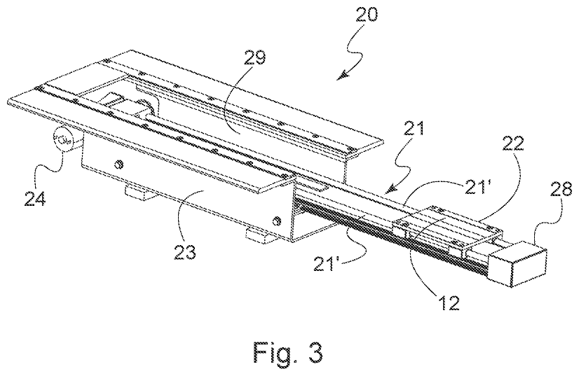

An embodiment of the horizontal conveyor device 20 for a recharging column 10 of electric or hybrid vehicles in an automated parking area is shown in greater detail in FIG. 3.

The horizontal conveyor device 20 advantageously has a horizontal guide 21 and a drag base 22 configured to be reversibly coupled to a hooking element 5 of a recharging column 10 of electric or hybrid vehicles.

The drag base 22 is configured to translate along the horizontal guide 21 between an at rest/recharging position and a conveying/forward position, which are described in greater detail hereunder.

Preferably, the horizontal guide 21 is represented by two parallel tracks 21′ extending from a supporting frame 23 configured to at least partially contain them.

The supporting frame 23 is like a parallelepiped box-shaped element and is configured to be housed inside a seat 39 of substantially corresponding shape obtained in the floor of the automated parking area.

In particular, in the floor of a parking spot 400 and/or interface platform 200 between the vehicle 300 to be parked and a carriage for moving vehicles, as will be specified hereunder.

In the embodiment shown in the figures, the tracks 21′ extend up to a maximum of 70%, preferably 60%, of their total length outside of the supporting frame 23.

In the embodiment shown in the figures, the drag plate 22 further has a motor 24 configured to transmit the translation movement to the drag base 22 along the horizontal guide 21.

For this purpose, a transmission member 25, such as belts 27 and pinions 26, is interposed between the motor 24 and the drag base 22.

A different transmission member 25 could be provided without thereby departing from the protection scope of the present invention.

In the embodiment shown in the figures, at least one end limit element 28, mounted at an end of the horizontal guide 21, is provided to define the outermost end stop of the drag base 22.

The end limit element 28 consequently defines the forward or conveying position of the drag base and recharging column 10.

Preferably, the supporting frame 23 can have a cover, not shown in the figures, configured to close, at least partially on top, the seat 29 intended to accommodate the horizontal guide 21 at least partially.

The at rest/recharging position of the drag base 22 is such that the drag base 22 itself, and consequently the column 10 positioned thereon, is away from the wheel of the vehicle, whereas the conveying position is such that the drag base 22, and consequently the column 10 positioned thereon, is adjacent to the wheel of the vehicle to be parked, such as the column 10 can be engaged together with the wheel of the vehicle with the teeth or clamping devices of the carriage for moving vehicles.

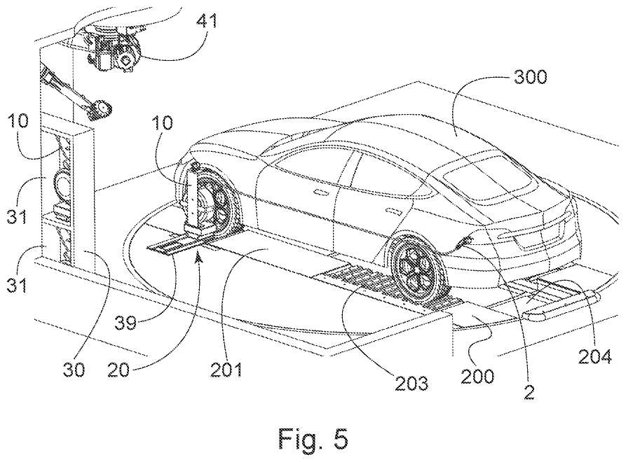

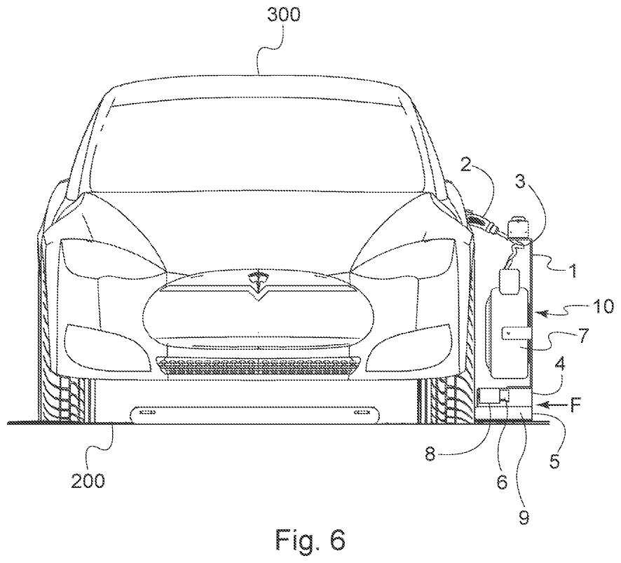

A vehicle 300 positioned on an interface platform 200 between the vehicle 300 to be parked and a carriage for moving vehicles is shown in FIGS. 5 and 6, the drag base 22, and consequently the column 10 constrained thereto and integral therewith, has just been displaced, as denoted by the arrow F, to the conveying/forward position. In this position, the carriage for moving vehicles can engage, together with the wheel of the vehicle, the recharging column 10 to convey it together with the vehicle 300 up to the parking spot 400, where the vehicle 300 will be recharged if needed.

Before displacing the drag base 22, and thus the column 10, to the conveying/forward position, the user has typically already taken care, by pulling electrical cable 3, to bring the first connector 2 into engagement with the corresponding connector of vehicle 300 to be recharged.

In this step, the first connector 2 is not electrically supplied, in other words, in this step the vehicle 300 is not subjected to being electrically recharged.

As briefly mentioned in the preceding paragraphs, the column 10 and the conveyor device 20 described above are part of a recharging system for recharging electric or hybrid vehicles in an automated parking area. In the context of the present invention, “automated parking area” means a parking area in which it is possible to position a vehicle in a first station and to subsequently, by means of user interface means, cause the activation of an automatic system for moving the vehicle which uses a movement carriage performing the translation, raising and/or lowering and/or rotation of said vehicle up to a parking area or parking station with a predetermined stall inside which the vehicle is specifically arranged in a predefined parking station or area, by means of an automatic movement procedure assisted by the control of an electronic processor and by electric motorized means for controlling said movement carriage.

The automated parking area comprises a recharging system for recharging electric or hybrid vehicles thus formed by at least one column 10 as previously described, at least one first conveyor device 20 arranged at the access space 40 for accessing the automated parking area and at least one second horizontal conveyor device 20 arranged at a parking spot of the automated parking area, the parking spot being typically arranged in a different space of the automated parking area.

Typically, several parking spots 400, at least a part of which can be configured for parking and recharging an electric or hybrid vehicle, are present in an automated parking area.

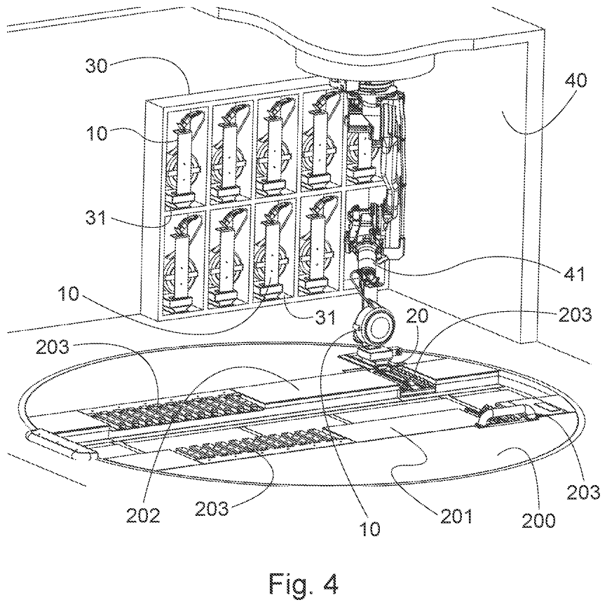

A portion of an access space 40 for accessing an automated parking area provided with the recharging system for recharging electric or hybrid vehicles according to the present invention is for example shown in FIGS. 4 and 5.

In the embodiment shown in FIGS. 4 and 5, the recharging system preferably comprises a plurality of recharging columns 10 for recharging electric or hybrid vehicles.

At least the same number of columns 10 as that of the parking spots 400 configured to accommodate the electric vehicles is generally provided.

The recharging columns 10 for recharging electric or hybrid vehicles are preferably in turn stored in an appropriate warehouse 30, if not allocated to a vehicle to be recharged.

In FIG. 4, the warehouse 30 is arranged in the same access space 40 of the automated parking area but could be arranged in another space, without thereby departing from the protection scope of the present invention.

In the embodiment shown in FIG. 4, the warehouse 30 comprises a plurality of cells 31 each intended to accommodate a recharging column 10. Each cell 31 being identifiable by coordinates stored in an appropriate electronic processor configured to control the recharging system for recharging electric or hybrid vehicles.

Always with reference to the embodiment shown in FIG. 4, it is possible to see an interface platform 200 between a vehicle 300 to be parked and a carriage for moving vehicles.

The interface platform 200 comprises side portions 201, 202 of drive demarcation, configured for the temporary parking of a vehicle 300 entering the automated parking area. It is possible to make a carriage for moving vehicles slide between the side portions 201, 202 of drive demarcation, preferably in an appropriate groove 204.

The interface platform 200 can be a rotating platform 200′.

A seat 39 for housing a first horizontal conveyor device 20 is provided in the interface platform 200 and especially in the floor of the latter.

The system further comprises a plurality of parking spots 400, each configured to store a vehicle and possibly recharge it.

The parking spots 400 are generally arranged in another space 50 and at another level of the automated parking area.

Different spaces, each provided with a plurality of parking spots 400, can be provided.

The parking spots 400 are typically provided with racks 401 for the wheels of the vehicle.

The racks 401 are arranged in parallel and spaced from one another such as to allow the insertion of a carriage for moving a vehicle between them, to collect or release the vehicle 300 to be stored and possible recharged.

At the parking spots 400 intended to accommodate the electric or hybrid vehicles to be recharged, in addition to a second horizontal conveyor device 20, a power socket 18, corresponding to the power socket 6, will precisely engage the power socket 6 if the process of recharging the electric or hybrid vehicle has been selected by the user.

The power socket is supported by an arm 18′ and is properly positioned for being coupled to the socket 6, when the drag plate 22 of the second horizontal conveyor device 20, and consequently the recharging column it carries, reaches its at rest/recharging position.

The power socket 18 is electrically supplied.

In other words, the vehicle 300 to be recharged reaches the parking spot 400 together with the recharging column 10. As better described hereunder, the carriage for moving the vehicle provides to release the vehicle 300 in the parking spot 400 dedicated thereto and to couple the recharging column 10 to the second horizontal conveyor device 20.

The second horizontal conveyor device 20 thus translates to its at rest/recharging position, bringing the recharging column 10 along with it and allowing the engagement between the power socket 6 and the power socket 18.

This way, the current flows from the power socket 18 to the first connector 2 and consequently to the vehicle 300 to be recharged.

The process of recharging electric or hybrid vehicles 300 in an automated parking area with a system such as the one described above starts with providing a vehicle 300 to be recharged to an interface platform 200 between a vehicle 300 to be parked and a carriage for moving vehicles of an automated parking area.

In other words, the vehicle 300 to be parked in the automated parking area and recharged is brought by the user on the interface platform 200.

The user further provides to couple the first connector 2 of the recharging column 10 to the corresponding connector of his/her vehicle 300, as shown for example in FIG. 5. Obviously, such operation could also be carried out by a third person accompanying the user or by a specifically dedicated operator, without thereby departing from the protection scope of the present invention.

The interface platform 200 is a platform which allows the coupling between the vehicle to be moved inside the automated parking area and a carriage for moving vehicles, such as for example the one described in the patent application WO2015177718 or in the patent application WO02075084 always in the name of the Applicant.

The interface platform 200 could be a rotating platform 200′ and could be located, like for the interface platforms of the known art, at the access space 40 of the automated parking area.

The interface platform 200 is provided with two couples of racks 203 for positioning the vehicle 300 to be moved and with one central groove 204 placed between the two couples of racks 203.

The racks 203 in fact extend in parallel and are spaced from one another.

The central groove 204 is such as to allow the insertion of the carriage for moving vehicles below the vehicle 300 to be moved and recharged.

The interface platform 200 is further provided with a seat 39 for housing a first horizontal conveyor device 20.

The first horizontal conveyor device 20 was previously coupled to a recharging column 10. In this step, both the drag base 22 and the recharging column 10 are in an at rest/recharging position, FIG. 4.

The first horizontal conveyor device 20 was preferably coupled to a recharging column 10 before the vehicle 300 entered the automated parking area.

In the embodiment shown in the figures, the first horizontal conveyor device 20 was coupled to a recharging column 10 by a robotic arm 41 which provided to remove the recharging column 10 from a cell 31 of the warehouse 30 and to position it coupled to the first horizontal conveyor device 20.

For coupling the rechargeable column 10 to the first horizontal conveyor device 20, the robotic arm 41 brings the recharging column 10 at, and more in detail above, the conveyor device 20, so that the reversible coupling means 11 of the recharging column 10 magnetically interact with the reversible coupling means 12 of the first horizontal conveyor device 20. This way, the recharging column 10 is physically constrained to the drag plate 22 and can move integrally therewith.

During the coupling between the recharging column 10 and the first conveyor device 20, the assembly is in the at rest/recharging position, i.e. in a position furthest away from the position in which the wheel of the vehicle 300 is expected to be positioned, FIG. 4.

When a vehicle 300 with the credentials needed to access the automated parking area comes into the space 40, the driver of the vehicle brings the vehicle at an interface platform 200.

In particular, the vehicle 300 is brought by the driver above the interface platform 200 with its wheels above the racks 203.

The carriage for moving vehicles can already be on the interface platform 200 and in particular inside its central groove 204.

Alternatively, the carriage is controlled such as it arrives on the interface platform 200 and positions itself below the vehicle 300.

The drag plate 22 of the first conveyor device 20 is thus controlled so that it translates the recharging column 10 to the conveying/forward position, i.e. in a position adjacent and close to the wheel of the vehicle 300 to be conveyed. Preferably, the recharging column 10 is positioned in contact with a wheel, typically a front one, of the vehicle 300 to be moved.

The recharging system for recharging electric or hybrid vehicles thus proceeds to couple at least one portion of the carriage for moving vehicles to the wheel of the vehicle 300, close to the recharging column 10, and to the recharging column 10.

The coupling between the portion of the movement carriage and the wheel of the vehicle 300 thus occurs such as to decouple the recharging column 10 from the first conveyor device 20.

In other words, the hooking element 5, gripped to the gripping member of the movement carriage, is unhooked and raised from the drag plate 22.

At this point, the vehicle 300, together with the recharging column 10, is brought by the carriage for moving vehicles on a parking spot 400 provided with a second horizontal conveyor device 20, where it will actually be recharged.

The parking spot 400 is generally arranged in another space 50 and at another level of the automated parking area.

The parking spots 400 are typically provided with racks 401 for the wheels of the vehicle, the carriage for moving vehicles thus proceeds through its gripping members to lower the wheels of the vehicle onto the appropriate racks 401.

By disengaging the wheel of the vehicle and the hooking element 5 from the gripping member of the carriage for moving vehicles, the recharging column 10 is also simultaneously coupled to the drag plate 22 of the second horizontal conveyor device 20.

For this purpose, the drag plate 22 of the second conveyor device 20 was previously brought to its conveying/forward position, i.e. in a forward position which, with the arrival of the vehicle 300, will be arranged at and adjacent to the vehicle wheel combined with the recharging column 10.

Once the recharging column 10 is hooked to the drag plate 22 of the second conveyor device 20, the recharging system provides to control the drag plate 22 so that it translates and returns to its at rest/recharging position.

The recharging system for recharging electric or hybrid vehicles in an automated parking area thus provides to control the translation of the drag plate 22 by controlling the motor 24 which in turn controls the transmission member 25.

The translation of the drag plate 22 of the second conveyor device 20 also involves the translation of the recharging column 10 combined therewith and thus simultaneously of its power socket 6.

When reaching its at rest/recharging position, the drag plate 22 brings the recharging column 10 along, the latter, and in particular its power socket 6, engages and couples to a corresponding power socket 18.

This way, the current flows from the power socket 18, through the electric cable 3, to the first connector 2 and consequently to the vehicle 300 to be recharged.

At the end of the parking time, which may or may not coincide with the end of the charging period, the system controls reverse operations.

In other words, the recharging column 10 is translated by the second horizontal conveyor device 20 to its conveying/forward position by disconnecting the power socket 6 from the power socket 18, thereby cutting off the power supply to the vehicle 300.

At this point, the carriage for moving vehicles arrives below the vehicle to hook the wheel of the vehicle and simultaneously the recharging column 10.

Once the vehicle 300 and recharging column 10 are hooked, the carriage for moving the vehicle brings the vehicle 300 on the interface platform 200.

At the interface platform 200, the carriage for moving the vehicle thus provides to couple the recharging column 10 to the drag plate 22 of the first conveyor device 20.

The aforesaid coupling occurs as the gripping portion of the carriage for moving vehicles is unhooked from the wheel of the vehicle 300 and from the hooking element 5 of the recharging column 10.

The decoupling between the gripping portion of the carriage for moving vehicles and the wheel of the vehicle 300 thus occurs such as to couple the recharging column 10 to the first conveyor device 20.

In other words, the hooking element 5, gripped to the gripping member of the carriage for moving vehicles, is unhooked and made to adhere to the drag plate 22.

At this point, the system controls the translation of the drag plate 22 and the recharging column 10 combined therewith to its at rest/recharging position.

The user can thus collect the vehicle 300 after having removed the first connector 2 from the corresponding connector of the vehicle 300.

The system can further control the collection of the recharging column 10 for storing it inside a cell 31 of the warehouse 30 or leaving it coupled to the first conveyor device 20.

Several changes can be made to the embodiments described in detail, all anyhow remaining within the protection scope of the invention as defined by the following claims.

1. Recharging column (10) for recharging electric or hybrid vehicles in an automated parking area, said column (10) extending substantially vertically and comprising:
a supporting upright (1) extending substantially vertically;
a power socket (6) positioned in said column (10), and
a first connector (2) configured to be coupled to a corresponding connector of the vehicle (300) to be recharged;
a current cable (3) provided with said first connector (2) at one end,
a power socket (6) configured for being coupled to a corresponding power socket outside of said recharging column (10) and from which to receive an electric power supply; said power socket (6) being electrically connected to said electric cable (3);
a base (4) configured to support said recharging column and to move on a drag base of a horizontal conveyor device to translate said column (10) between an at rest/recharging position and a conveying/forward position;
a hooking element (5) integral with said base (4) and comprising reversible coupling means for coupling with a carriage for moving vehicles; said hooking element (5) comprising reversible coupling means (11) for coupling to a drag base (22) of a horizontal conveyor device (20).

2. Recharging column (10) for recharging electric or hybrid vehicles in an automated parking area according to claim 1, characterized in that said power socket (6) is integral with said base (4) to translate together with said base (4).

3. Recharging column (10) for recharging electric or hybrid vehicles in an automated parking area according to claim 1, characterized in that said hooking element (5) comprises two recesses (9) configured to allow the insertion of a grip portion of a carriage for moving vehicles.

4. Recharging column (10) for recharging electric or hybrid vehicles in an automated parking area according to claim 1, characterized in that said reversible coupling means (11) are configured to interact magnetically with the corresponding reversible coupling means (12) of a drag base (22) of a horizontal conveyor device (20).

5. Horizontal conveyor device (20) for a recharging column (10) of electric or hybrid vehicles in an automated parking area; said conveyor device (20) comprising:
a horizontal guide (21);
a drag base (22) configured to be reversibly coupled to a hooking element (5) of a recharging column (10) of electric or hybrid vehicles in an automated parking area; said drag base (22) being configured to translate along said horizontal guide (21) between an at rest/recharging position and a conveying/forward position;
a motor (24) configured to transmit the translation movement to said drag base (22);
a supporting frame (23) configured to at least partially contain said horizontal guide (21).

6. Horizontal conveyor device (20) according to claim 5, characterized by comprising reversible coupling means (12) for coupling to a hooking element (5) of a recharging column (10) for recharging electric or hybrid vehicles.

7. Recharging system for recharging electric or hybrid vehicles in an automated parking area, comprising:
at least one recharging column (10) according to any one of claims 1 to 4;
at least one first conveyor device (20) according to any one of claims 5 to 6; said first conveyor device (20) being arranged at an interface platform (200) between the vehicle to be parked and a carriage for moving vehicles in an automated parking area;
at least one second conveyor device (20) according to any one of claims 5 to 6; said second conveyor device (20) being arranged at a parking spot (400) of a vehicle in an automated parking area.

8. Recharging system for recharging electric or hybrid vehicles in an automated parking area according to claim 7, comprising a plurality of recharging columns (10) for recharging electric or hybrid vehicles in an automated parking area.

9. Recharging system for recharging electric or hybrid vehicles in an automated parking area according to claim 7 or 8, comprising a robotic arm (41) configured to move said columns (10) from a storage position to a coupled position with said first conveyor device (20) and vice-versa.

10. Recharging system for recharging electric or hybrid vehicles in an automated parking area according to claim 6 or 7, characterized by comprising a storage warehouse (30) for storing said plurality of recharging columns (10), said storage warehouse (30) being positioned at said interface platform (200) between the vehicle to be parked and a carriage for moving vehicles in an automated parking area.

11. Process of recharging electric or hybrid vehicles in an automated parking area with a recharging system for recharging electric or hybrid vehicles according to any one of claims 7 to 10, said recharging process comprising the steps of:
providing a vehicle (300) to be recharged to an interface platform (200) between the vehicle and a carriage for moving vehicles; said interface platform (200) being combined with a first horizontal conveyor device (20) according to claim 5 or 6; said first horizontal conveyor device (20) being in turn coupled to a recharging column (10) according to any one of claims 1 to 4, the drag plate (22) and said recharging column (10) being in their at rest/recharging position;
bringing said drag plate (22) and said recharging column (10) to a conveying/forward position;
bringing a carriage for moving vehicles below said vehicle (300);
coupling at least one portion of said carriage for moving vehicles to at least one wheel of said vehicle (300) and to said recharging column (10); such as to decouple said recharging column (10) from said first horizontal conveyor device (20);
conveying said vehicle (300) together with said recharging column (10) on a parking spot (400) provided with a second horizontal conveyor device (20);
coupling said recharging column (10) to the drag plate (22) of said second horizontal conveyor device (20);
translating said drag plate (22) of said second conveyor device (20) together with said recharging column (10) in its at rest/recharging position such as the power socket (6) of said column (10) is engaged with and is electrically supplied by a corresponding power socket (18).

12. Process of recharging electric or hybrid vehicles in an automated parking area according to claim 11, wherein the step of coupling at least one portion of said carriage for moving vehicles to at least one wheel of said vehicle (300) and to said recharging column (10) provides for the engagement of a gripping member of said carriage for moving vehicles with said hooking element (5) and the raising of said hooking element (5) to decouple the reversible coupling means (11) of the recharging column (10) from the corresponding reversible coupling means (12) of the drag base (22) of a horizontal conveyor device (20).

13. Process of recharging electric or hybrid vehicles in an automated parking area according to claim 11, wherein the step of coupling said recharging column (10) to the drag plate (22) of said second horizontal conveyor device (20) occurs by coupling said hooking element (5) to said drag base (22) such as to couple the reversible coupling means (11) of the recharging column (10) to corresponding reversible coupling means (12) of the second conveyor device (20).
